(19) United States
(12) Patent Application Publication
(10) Pub. No.: US 2025/0342539 A1
(43) Pub. Date: Nov. 6, 2025

(54) METHOD FOR INCORPORATING FUTURE CROP PRODUCTION INTO SAFE CLIMATIC SPACE

(71) Applicant: China Agricultural University, Beijing (CN)

(72) Inventors: Wenfeng LIU, Beijing (CN); Chuanliang LI, Beijing (CN)

(21) Appl. No.: 19/196,029

(22) Filed: May 1, 2025

(30) Foreign Application Priority Data
May 6, 2024 (CN) 202410550405.6

(51) Int. Cl. G06Q 50/02

(52) U.S. Cl. CPC G06Q 50/02

(57) ABSTRACT

Provided is a method for incorporating a future crop production into a safe climatic space (SCS), including: calculating indicator data according to climatic data of a preset region in a baseline period, and constructing a first SCS by combining the indicator data with production data of a crop in the baseline period; adjusting the climatic data, such that the first SCS moves, and a moving range of the first SCS is combined with the first SCS to form a second SCS, and according to climatic data in a future period, screening optimal indicator data when a production of the crop within SCS is maximum; and constructing a third SCS of the crop with the optimal indicator data of the crop, and optimizing a planting area distribution of the crop to improve a production of the crop in the third SCS.

### CROSS-REFERENCE TO RELATED APPLICATIONS

This patent application claims the benefit of and priority to Chinese Patent Application No. 202410550405.6, filed with the China National Intellectual Property Administration on May 6, 2024, the disclosure of which is incorporated by reference herein in its entirety as part of the present application.

### TECHNICAL FIELD

The present disclosure relates to the field of climate change and agricultural production, and in particular to a method for incorporating a future crop production into a safe climatic space (SCS).

### BACKGROUND

At present, climatic characteristics have experienced a dramatic change as the Earth's surface temperature rises substantially. Extreme heat and extreme precipitation events show an upward trend in both frequency and intensity. Climate change is closely associated with constituents of food security. To meet the future food demand of an ever-increasing population, it is crucial to mitigate the impacts of extreme climates. The climate change has threatened the productivity of crops, particularly maize, wheat, rice, and oil crops like soybean.

For the adverse impact of the climate change on the crop production, certain measures are urgently needed to reduce the production losses and mitigate the impact of the climate change on the crop production, which is of great significance to global food security. Presently, a SCS is proposed in related art. The SCS is defined as climatic conditions to which the current food production system (only the crop production) is adapted by using a combination of three climatic parameters, i.e., annual precipitation (P), biotemperature (bioT), and aridity (R), in an integrated way. However, the research on the SCS is only confined to prediction for impact of future climate change on the crop production, without considering how to eliminate or mitigate the impact caused by the future climate change.

### SUMMARY

The present disclosure is intended to resolve at least one of technical problems in the related art to some extent. In view of this, an objective of the present disclosure is to provide a method for incorporating a future crop production into the SCS, such that a greater proportion of the future crop production falls within the SCS, thereby mitigating the impact of the future climate change on the crop production to ensure food security.

To achieve the above-mentioned objective, the present disclosure provides a method for incorporating a future crop production into an SCS, including:
calculating indicator data according to climatic data of a preset region in a baseline period, and constructing a first SCS by combining the indicator data with production data of a crop in the baseline period;
adjusting the climatic data, such that the first SCS moves, and a moving range of the first SCS is combined with the first SCS to form a second SCS; and according to climatic data in a future period, screening optimal indicator data when a production of the crop is maximum; and
constructing a third SCS of the crop with the optimal indicator data of the crop, and optimizing a planting area distribution of the crop to improve a production of the crop in the third SCS.

In some embodiments, the climatic data includes temperature and precipitation data; and the indicator data includes annual precipitation, biotemperature, and aridity.

In some embodiments, the annual precipitation is calculated as follows:

$$P = {\sum }_{i}^{days} {p}_{i}$$

where P is the annual precipitation, mm; p is daily precipitation, mm; and days are a number of days in a year, days.

In some embodiments, the biotemperature is calculated as follows:

$$bioT = {\sum }_{i}^{days} {t}_{i} / days$$

where bioT is the biotemperature, ° C.; t is a daily average temperature less than 35° C. and greater than 0° C., ° C.; and days are a number of days in a year, days.

In some embodiments, the aridity is calculated as follows:

$$R = \frac{EVP}{P}$$

where R is the aridity; EVP is potential evapotranspiration, mm; and P is the annual precipitation, mm; and
the potential evapotranspiration is calculated as follows:

$$EVP = 58.93 \times bioT$$

where bioT is the biotemperature, ° C.

In some embodiments, corresponding indicator data is calculated according to the climatic data in the future period, to determine whether a future production of the crop in the preset region is affected by a climate change.

In some embodiments, the planting area distribution of the crop is optimized by a genetic algorithm (GA); and an optimization program is edited with Matlab, including population generation, selection, crossover, and mutation.

In some embodiments, during optimization on the planting area distribution of the crop, parameters of the GA, including a variation of irrigation water and a variation of a planting area, are constrained.

Compared with the prior art, the present disclosure has the following advantages:

The present disclosure improves the adaptability of the crop to the future climate and optimizes the planting area distribution of the crop, such that a greater proportion of the future crop production falls within the SCS, thereby mitigating impact of the future climate change on the crop production to ensure future food security.

Some of additional aspects and advantages of the present disclosure will be provided in the following description, and some become evident in the following description or understood through the practice of the present disclosure.

### BRIEF DESCRIPTION OF THE DRAWINGS

The foregoing and/or additional aspects and advantages of the present disclosure will become apparent and easily understandable from the following descriptions of the embodiments with reference to the accompanying drawings.

FIG. 1 illustrates a flowchart of a method for incorporating a future crop production into an SCS according to an embodiment of the present disclosure;

FIGS. 2A-2B illustrate an SCS constructed according to an embodiment of the present disclosure, where the area enclosed by an arc represents the SCS, while other signs represent a number of models not within the SCS, triangle-1, rhombus-2, square-3, inverted triangle-4, and plus sign-5;

FIG. 3 illustrates an adaptive optimization process according to an embodiment of the present disclosure; and

FIG. 4 illustrates a flowchart of a GA according to an embodiment of the present disclosure.

### DETAILED DESCRIPTION OF THE EMBODIMENTS

The embodiments of the present disclosure are described below in detail. The examples of the embodiments are shown in the drawings. The same or similar numerals represent the same or similar elements or elements having the same or similar functions throughout the specification. The embodiments described below with reference to the drawings are exemplary, and are merely intended to explain the present disclosure, rather than to limit the present disclosure. Conversely, the embodiments of the present disclosure include all alterations, modifications and equivalents falling within the range of spirit and connotation of the appended claims.

To achieve the above-mentioned objective, the present disclosure provides a method for incorporating a future crop production into an SCS, including:
S1: Indicator data is calculated according to climatic data of a preset region in a baseline period, and a first SCS is constructed by combining the indicator data with production data of a crop in the baseline period.
S2: The climatic data is adjusted, such that the first SCS moves, and a moving range of the first SCS is combined with the first SCS to form a second SCS. According to climatic data in a future period, optimal indicator data when a production of the crop is maximum is screened.
S3: A third SCS of the crop is constructed with the optimal indicator data of the crop, and a planting area distribution of the crop is optimized to improve a production of the crop in the third SCS.

In the step S1, the indicator data is calculated according to the climatic data of the preset region in the baseline period. That is, a region is selected. According to climatic data of the region in the baseline period, such as temperature and precipitation data, indicator data for constructing a first SCS is calculated. The indicator data includes annual precipitation, biotemperature and aridity.

The annual precipitation in the embodiment is calculated as follows:

$$P = {\sum }_{i}^{days} {p}_{i}$$

where P is the annual precipitation, mm; p is daily precipitation, mm; and days are a number of days in a year, days.

The biotemperature is calculated as follows:

$$bioT = {\sum }_{i}^{days} {t}_{i} / days$$

where bioT is the biotemperature, ° C.; t is a daily average temperature less than 35° C. and greater than 0° C., ° C.; and days are a number of days in a year, days.

The aridity is calculated as follows:

$$R = \frac{EVP}{P}$$

where R is the aridity; EVP is potential evapotranspiration, mm; and P is the annual precipitation, mm.

The potential evapotranspiration is calculated as follows:

$$EVP = 58.93 \times bioT$$

where bioT is the biotemperature, ° C.

After the annual precipitation, biotemperature and aridity of the selected region are obtained, the first SCS is constructed in combination with production data of a crop of the region in the baseline period.

In the step S2, as can be seen, when a variation range for the temperature and precipitation data is set, the original first SCS moves, and a moving range is combined with the original first SCS to generate a new SCS, namely a second SCS. In other words, by changing adaptability of the crop in the region for the temperature and precipitation, namely changing the temperature and precipitation data in the baseline period, the first SCS moves, and a moving range of the first SCS is combined with the original first SCS to obtain the new and expanded second SCS. Through temperature, precipitation and crop production data in the future period simulated by different global crop models, a proportion of the crop beyond the first SCS can be calculated.

According to the climatic data of the region in the future period, the optimal indicator data when the production of the crop is maximum is screened. That is, according to temperature and precipitation data in the future period, a condition where the production of the crop is maximum in the second SCS based on the climatic data in the future period is investigated. The indicator data when the production of the crop is maximum is also adaptability of the crop to be improved. Corresponding indicator data is calculated according to the climatic data in the future period, to determine whether a future production of the crop in the preset region is affected by a climate change.

In the step S3, based on improvement of the adaptability of the crop in the step S2, a new SCS is constructed to serve as a third SCS, and a planting area distribution of the crop is optimized by a GA to improve a production of the crop in the third SCS. That is, the planting areas of the crop in the third SCS are optimized by the GA. An optimization program is edited with Matlab, including population generation, selection, crossover, and mutation. This further improves the production of the crop in the third SCS, to mitigate the impact of the future climate change on the crop production. During optimization of this step, parameters of the GA, including a variation of irrigation water and a variation of a planting area, are constrained, without affecting the local plantation structure and water utilization structure greatly.

The present disclosure improves the adaptability of the crop for temperature and precipitation change to expand the original SCS, such that a greater proportion of the future crop production falls within the newly formed SCS. Then, the present disclosure optimizes the distribution of the crop based on the GA to increase the future production of the crop in the SCS, thereby mitigating the impact of the future climate change on the crop production to ensure future food production.

### Embodiment 1

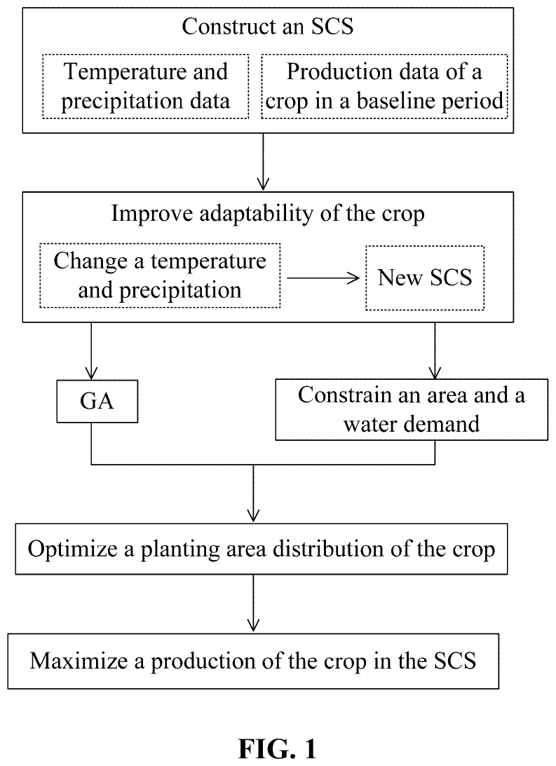

As shown in FIG. 1, the embodiment provides a method for incorporating a future crop production into an SCS. In the embodiment, climatic data of Global Soil Wetness Project Phase 3 (GSWP3) in Table 1 is used in the baseline period. Climatic data simulated by five global climate models of Coupled Model Intercomparison Project Phase 6 (CMIP6) is used in the future period. The production data is crop production data simulated by crop models (EPIC-IIASA, LPJmL, pDSSAT, and PEPIC). The crops include maize, soybean, rice and wheat. Besides, China serves as the preset region in the embodiment. The climatic data in the embodiment is shown in Table 1.

TABLE 1
Source of the climatic data

| Period | Experimental period | Data source |
|---|---|---|
| Baseline period | 1987-2016 | GSWP3 |
| | | GFDL-ESM4 |
| | | IPSL-CM6A-LR |
| Future period | 2036-2065 | MPI-ESM1-2-HR |
| | | MRI-ESM2-0 |
| | | UKESM1-0-LL |

Indicator data for constructing a first SCS can be calculated based on climatic data in the baseline period. The indicator data includes annual precipitation, biotemperature, and aridity. The annual precipitation in the embodiment is calculated as follows:

$$P = {\sum }_{i}^{days} {p}_{i}$$

where P is the annual precipitation, mm; p is daily precipitation, mm; and days are a number of days in a year, days.

The biotemperature is calculated as follows:

$$bioT = {\sum }_{i}^{days} {t}_{i} / days$$

where bioT is the biotemperature, ° C.; t is a daily average temperature less than 35° C. and greater than 0° C., ° C.; and days are a number of days in a year, days.

The aridity is calculated as follows:

$$R = \frac{EVP}{P}$$

where R is the aridity; EVP is potential evapotranspiration, mm; and P is the annual precipitation, mm.

The potential evapotranspiration is calculated as follows:

$$EVP = 58.93 \times bioT$$

where bioT is the biotemperature, ° C.

By combining the annual precipitation, biotemperature and aridity with production data in the baseline period, the first SCS in China can be obtained.

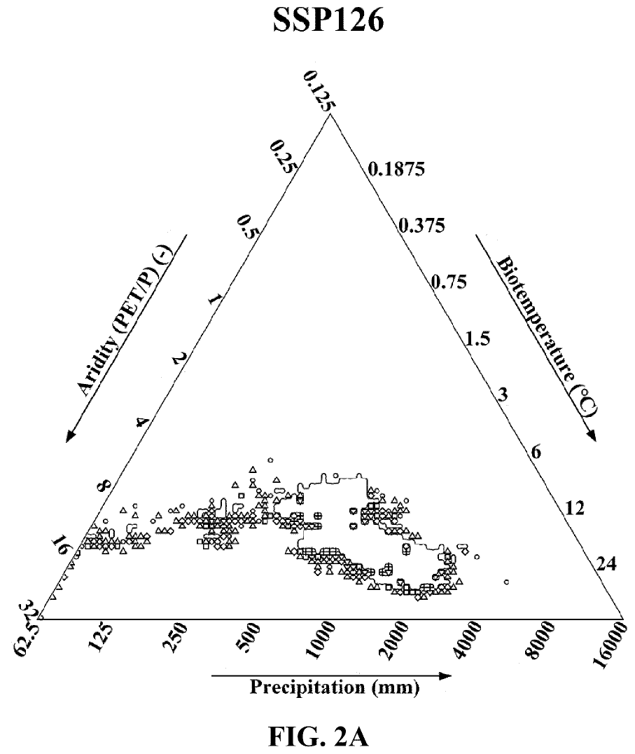

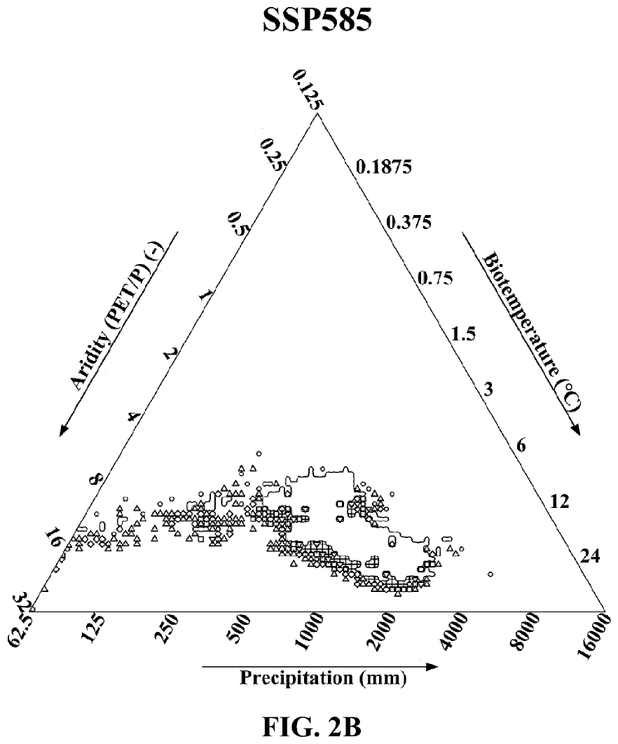

According to climatic data and production data of a crop in the future period, a proportion exceeding the crop production of the first SCS in the future period can be calculated. By changing adaptability of the crop for the temperature and precipitation, the first SCS moves, and a moving range of the first SCS is combined with the original first SCS to obtain a new expanded second SCS. During optimization, for example, by limiting a variation range of the temperature at 0-3° C., with a step size of 0.1° C. each time, and limiting a variation range of the precipitation at −100 mm to 100 mm, with a step size of 10 mm each time, there are 600 adaptive solutions in total. A solution in which a production of the crop is maximum in the second SCS is selected, as shown in FIGS. 2A-2B. In FIGS. 2A-2B, the area enclosed by an arc represents the SCS, while other signs represent a number of models not within the SCS. The numeral represents a number of models at this point, namely triangle-1, rhombus-2, square-3, inverted triangle-4, and plus sign-5. For example, the triangle indicates that results simulated by one model are located at this point. Different models may exceed the SCS in varying ranges, and the signs represent a number of overlaps.

It is to be noted that the embodiment merely provides variations of the temperature and precipitation to which the crop is adapted, and the final changed values of the temperature and precipitation are as shown in Table 2.

TABLE 2
Values of temperature and precipitation
to which the crop is adapted

| | |
|---|---|
| SSP126 | SSP585 |

| Crop | Pr/(mm) | T/(° C.) | Pr/(mm) | T/(° C.) |
|---|---|---|---|---|
| Maize | 0 | 1.1 | −50 | 2.2 |
| Soybean | −10 | 1.6 | −80 | 2.4 |
| Rice | 0 | 1.2 | −80 | 2.6 |
| Wheat | −30 | 1.8 | −100 | 3 |

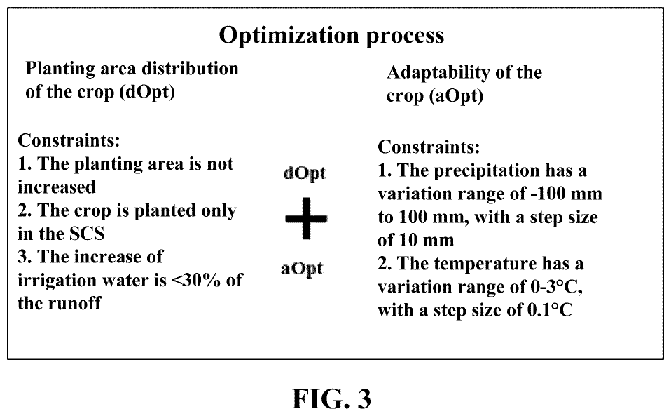

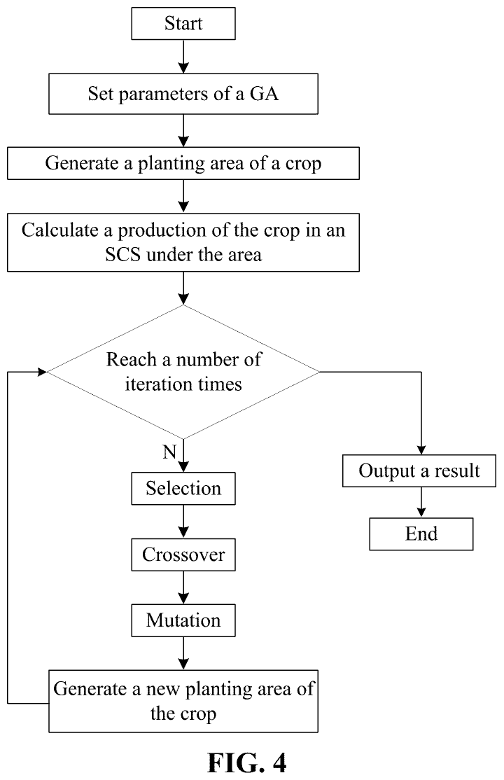

While the adaptability of the crop is optimized, the planting area distribution of the crop in the future period is optimized by the GA, as shown in FIG. 3. Besides, as shown in FIG. 4, the planting areas of the crop in the third SCS are optimized by the GA. An optimization program is edited with Matlab, including population generation, selection, crossover, and mutation. During optimization, the impact on the local plantation structure and water utilization structure is mitigated as much as possible. The total planting area must remain unchanged before and after optimization. For each crop in each region, the variation in planting area cannot exceed 20% of the original planting area. If some crop has never been planted in the region, the area of the unplanted crop cannot exceed 20% of the total planting area in that region. For the water demand of the crop, the increase of the water demand for the optimization in each region cannot exceed 30% of local runoff.

The embodiment optimizes the adaptability of the crop and the distribution of the crop, such that 99% of the future crop production falls within the third SCS, thereby mitigating impact of the future climate on the crop production in China.

It should be noted that terms such as “first” and “second” in the description of the present disclosure are used only for describing the present disclosure and are not intended to indicate or imply relative importance. In addition, in the description of the present disclosure, unless otherwise specified, “multiple” means two or more.

Any process or method description in the flowchart or described in other manners herein can be understood as representing a module, segment, or part of code that includes one or more executable instructions for implementing steps of specific logical functions or steps of the process. In addition, the scope of the preferred implementations of the present disclosure includes additional implementations, which may not be in the order shown or discussed, including performing functions in a substantially simultaneous manner or in a reverse order according to the functions involved. This should be understood by a person skilled in the art to which the embodiments of the present disclosure belong.

In the description of this specification, the description with reference to the terms such as “one embodiment”, “some embodiments”, “an example”, “a specific example”, or “some examples” means that the specific features, structures, materials, or characteristics described with reference to the embodiment or example are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

Although the embodiments of the present disclosure have been shown and described above, it can be understood that the aforementioned embodiments are exemplary and should not be construed as limiting the present disclosure. A person of ordinary skill in the art can make changes, modifications, replacements, and variants on the aforementioned embodiments within the scope of the present disclosure.

What is claimed is:

1. A method for incorporating a future crop production into a safe climatic space (SCS), comprising:
calculating indicator data according to climatic data of a preset region in a baseline period, and constructing a first SCS by combining the indicator data with production data of a crop in the baseline period;
adjusting the climatic data, such that the first SCS moves, and a moving range of the first SCS is combined with the first SCS to form a second SCS; and according to climatic data in a future period, screening optimal indicator data when a production of the crop is maximum; and
constructing a third SCS of the crop with the optimal indicator data of the crop, and optimizing a planting area distribution of the crop to improve a production of the crop in the third SCS.

2. The method according to claim 1, wherein the climatic data comprises temperature and precipitation data; and the indicator data comprises annual precipitation, biotemperature and aridity.

3. The method according to claim 2, wherein the annual precipitation is calculated as follows:
$$P = {\sum }_{i}^{days} {p}_{i}$$
wherein P is the annual precipitation, mm; p is daily precipitation, mm; and days are a number of days in a year, days.

4. The method according to claim 2, wherein the biotemperature is calculated as follows:
$$bioT = {\sum }_{i}^{days} {t}_{i} / days$$
wherein bioT is the biotemperature, ° C.; t is a daily average temperature less than 35° C. and greater than 0° C., ° C.; and days are a number of days in a year, days.

5. The method according to claim 2, wherein the aridity is calculated as follows:
$$R = \frac{EVP}{P}$$
where R is the aridity; EVP is potential evapotranspiration, mm; and P is the annual precipitation, mm; and
the potential evapotranspiration is calculated as follows:
$$EVP = 58.93 \times bioT$$
wherein bioT is the biotemperature, ° C.

6. The method according to claim 1, wherein corresponding indicator data is calculated according to the climatic data in the future period, to determine whether a future production of the crop in the preset region is affected by a climate change.

7. The method according to claim 1, wherein the planting area distribution of the crop is optimized by a genetic algorithm (GA); and
an optimization program is edited with Matlab, comprising population generation, selection, crossover, and mutation.

8. The method according to claim 1, wherein during optimization on the planting area distribution of the crop, parameters of the GA, comprising a variation of irrigation water and a variation of a planting area, are constrained.
